(19) United States
(12) Patent Application Publication
(10) Pub. No.: US 2026/0182500 A1
(43) Pub. Date: Jul. 2, 2026

(54) Double Baler Chamber Divider

(71) Applicant: AGCO Corporation, Duluth, GA (US)

(72) Inventors: Patrick L. Cherney, Hesston, KS (US); Kelly B. Booton, Hesston, KS (US)

(21) Appl. No.: 19/130,741

(22) PCT Filed: Jul. 11, 2023
(86) PCT No.: PCT/IB2023/057113

§ 371 Date: May 16, 2025

Related U.S. Application Data
(60) Provisional application No. 63/384,266, filed on Nov. 18, 2022.

(51) Int. Cl. A01F 15/04

(52) U.S. Cl. CPC A01F 15/046

(57) ABSTRACT

An agricultural baler having a pickup assembly configured to take cut plant material from the ground and move the plant material to a baling chamber and compress the plant material with a reciprocating plunger into a growing bale. The baling chamber is formed with a floor, a roof and opposing side walls. The baler includes a stationary knife mounted in the baling chamber extending vertically between the floor and the roof. A dividing partition extends rearward from the knife from the roof to the floor and intermediate the side walls of the baling chamber such that plant material is split by movement of the plunger relative to the knife and pushed into first and second bale-forming compartments to simultaneously form a first bale in the first bale-forming compartment on one side of the dividing partition and a second bale in the second bale-forming compartment on an opposite side of the dividing partition.

### BACKGROUND

### Field

This disclosure relates to agricultural harvesting machines such as balers and, more particularly, to a baler that simultaneously forms multiple bales of plant material.

### Description of Related Art

Conventional square hay balers include a bale forming chamber and a reciprocating plunger that slides into and out of the chamber. “Square” bales are often preferred in that the square-shouldered bales facilitate stacking, delivery and use and, as used herein, square bales means bales having square shoulders. As the chamber receives loose hay material, the plunger slides into the chamber during a compaction stroke to compress the loose hay material into the form of a bale. Such balers typically include a drive train that transmits power to the reciprocating plunger.

Attempts to improve baling efficiency have included the production larger balers that produce very large, high density bales. These large square bales are heavy and impossible to move by hand, making them undesirable for the small hobby farmer. Attempts have been made to use larger balers to produce bales of a reduced size in pairs such as by U.S. Pat. No. 3,099,203 to Klemm et al. and U.S. Pat. No. 10,869,428 to Grady. It would be desirable to have an improved baler that simultaneously forms multiple bales.

### BRIEF SUMMARY

In one aspect the invention is directed to an agricultural baler having a pickup assembly configured to take cut plant material from the ground and move the plant material to a baling chamber and compress the plant material in the baling chamber with a reciprocating plunger into a growing bale. The baling chamber is formed with a floor, a roof and opposing side walls. The baler includes a stationary knife mounted in the baling chamber extending vertically between the floor and the roof. A dividing partition extends rearward from the knife from the roof to the floor and intermediate the side walls of the baling chamber such that plant material moved into the baling chamber is split by movement of the plunger relative to the knife and pushed into first and second bale-forming compartments to simultaneously form a first bale in the first bale-forming compartment on one side of the dividing partition and a second bale in the second bale-forming compartment on an opposite side of the dividing partition.

These and other features and advantages of this invention are described in, or are apparent from, the following detailed description of various exemplary embodiments of the systems and methods according to this invention.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a side elevation view of an example baler machine configured to receive loose plant material and shape and secure the material into a bale;

FIG. 2 is a perspective view of a baling chamber of the baler of FIG. 1; and

FIG. 3 is a perspective view of the baling chamber of FIG. 2 with portions of the baling chamber cut away to show features of the baling chamber.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

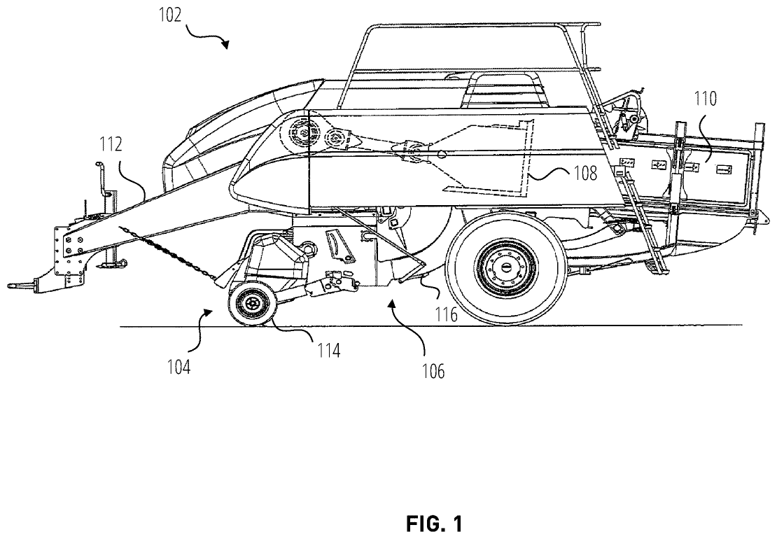

Referring to FIG. 1, an example agricultural baler 102 is shown into which embodiments of the present invention may be incorporated. Although the example baler 102 is a towed square baler, it will be appreciated that embodiments of the present invention may be incorporated into other types of balers (e.g., self-propelled) with few or no changes. Broadly, the baler 102 may be configured to move over a field and collect previously cut plant material and to compress, shape, and secure the collected plant material into a plurality of bales. The baler 102 may generally include a pickup assembly 104, a stuffer chute assembly 106, a reciprocating plunger 108, and a baling (or compression) chamber 110. Additionally, the baler 102 may be hitched to a towing vehicle (not shown) by a tongue 112, and power for operating the various mechanisms (e.g., the reciprocating plunger 108) of the baler 102 may be supplied by a power take-off of the towing vehicle.

The pickup assembly 104 may be configured to collect the cut plant material from the field. In one implementation, the pickup assembly 104 may include a pair of ground wheels 114 that support the pickup assembly 104 as the baler 102 moves over the field. The stuffer chute assembly 106 may be configured to direct the collected plant material into position for incorporation into a bale. In one implementation, the stuffer chute assembly 106 may include a charge-forming duct 116 extending from an inlet opening adjacent to the pickup assembly 104 to an outlet opening into the baling chamber 110. The reciprocating plunger 108 may be configured to compress the plant material from the charge-forming duct 116 into a growing bale. In one implementation, the plunger 108 may be configured to reciprocate within the baling chamber 110 in repeating compression and retraction strokes across the outlet opening of the charge-forming duct 116. As the plunger 108 retracts, the outlet opening is uncovered and an additional flake, charge, or other subunit of plant material enters the baling chamber 110, and as the plunger 108 contracts the outlet opening is covered and the additional subunit of plant material is compressed into the growing bale.

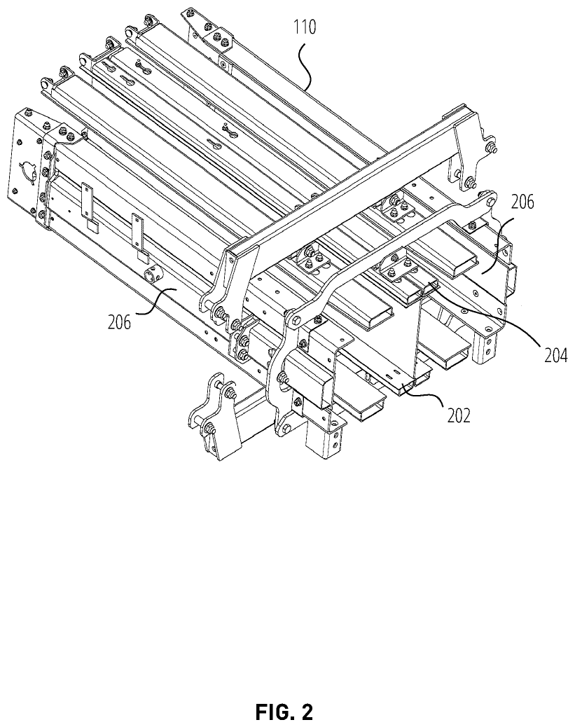

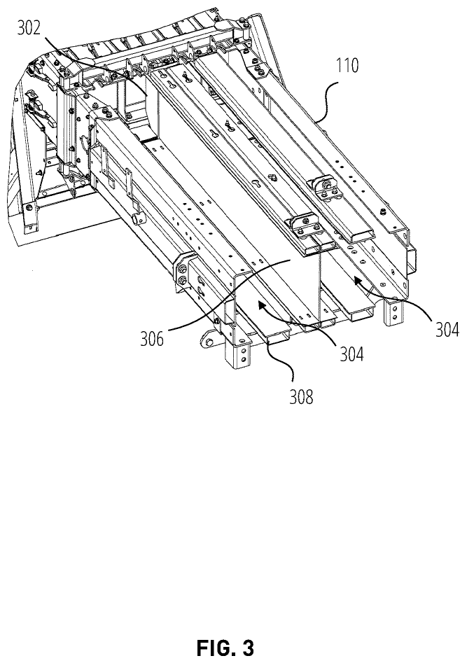

Turning now to FIGS. 2 and 3, the baling chamber 110 is formed with a floor 202, a roof 204 and opposing side walls 206. The reciprocating plunger 108 may be configured to compress the plant material from the charge-forming duct 116 into the space between the floor 202, the roof 204 and the side walls 206 of the baling chamber 110. FIG. 3 illustrates the baling chamber 110 with a portion of the roof 204 removed for clarity. The plunger 108 is hydraulically moved rearward to compress the plant material received in the baling chamber 110 from the stuffer chute assembly 106 such that the plunger 108 pushes the crop material against and past a stationary splitting knife 302 which extends vertically in the baling chamber 110 between the floor 202 and the roof 204 in a plane parallel with the side walls 206. The compressed crop material split by movement of the plunger 108 relative to the knife 302 is pushed into separate bale-forming compartments 304. The plunger 108 comes close to contacting the knife 302 but, preferably, does not contact the knife 302.

As seen in FIGS. 2 and 3, the two bale-forming compartments 304 are separated by a dividing partition 306 that extends rearward from the splitting knife 302 and is generally in a plane parallel with the side walls 206 of the baling chamber 110. Desirably, the dividing partition 306 extends to a discharge end of the baling chamber 110. The dividing partition 306 is secured in the baling chamber 110 with suitable mounting means in the roof 204 and the floor 202 using sound engineering judgment. The compressed crop material pushed into the bale-forming compartments 304 is simultaneously formed into first and second bales, with the first bale formed in the bale-forming compartment 304 on one side of the dividing partition 306 and the second bale formed in the bale-forming compartment 304 on the other side of the dividing partition 306.

As is known in the art, the floor 202, roof 204, and side walls 206 of the baling chamber 110 form a compression chamber controlled by hydraulic cylinders with the use of a computer. Desirably, the baling chamber 110 squeezes the top, bottom and outside sides of the first and second bales to achieve the desired weight and size of each bale. After the first and second bales reach the desired weight and size, the first and second bales are tied by a suitable knotter mechanism (not shown) as would be understood by one skilled in the art and expelled out the discharge end 308 of the baling chamber 110.

The baling chamber 110 may be configured to shape the growing bale and secure the compressed plant material in the individual bale. Control of the size and weight of the two bales formed in the first and second portions of the baling chamber 110 is achieved by suitable which sense the parameters of each of the bales and provide an indication of any need to vary the flow of crop material to the baling chamber. The finished bale may be ejected rearwardly to land on the field behind the baler for subsequent collection.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

1. An agricultural baler having a pickup assembly configured to take cut plant material from the ground and move the plant material to a baling chamber and compress the plant material in the baling chamber with a reciprocating plunger into a growing bale, the baling chamber being formed with a floor, a roof and opposing side walls, the baler comprising:
a stationary knife mounted in the baling chamber extending vertically between the floor and the roof; and
a dividing partition extending rearward from the knife to a discharge end of the baling chamber, wherein the dividing partition extends from the roof to the floor of the baling chamber and is intermediate the side walls of the baling chamber such that plant material moved into the baling chamber is split by movement of the plunger relative to the knife and pushed into first and second bale-forming compartments to simultaneously form a first bale in the first bale-forming compartment on one side of the dividing partition and a second bale in the second bale-forming compartment on an opposite side of the dividing partition.

2. The agricultural baler of claim 1 wherein the dividing partition is in a plane parallel with the side walls of the baling chamber.

3. (canceled)
